(19) United States
(12) Patent Application Publication
(10) Pub. No.: US 2013/0117543 A1
(43) Pub. Date: May 9, 2013

(54) LOW OVERHEAD OPERATION LATENCY AWARE SCHEDULER

(71) Applicants: Ganesh Venkataramanan, Sunnyvale, CA (US); Michael G. Butler, San Jose, CA (US)

(72) Inventors: Ganesh Venkataramanan, Sunnyvale, CA (US); Michael G. Butler, San Jose, CA (US)

(73) Assignee: ADVANCED MICRO DEVICES, INC., Sunnyvale, CA (US)

(21) Appl. No.: 13/289,428

(22) Filed: Nov. 4, 2011

(51) Int. Cl. G06F 9/30

(52) U.S. Cl. 712/220; 712/E09.016

(57) ABSTRACT

A method and apparatus for processing multi-cycle instructions include picking a multi-cycle instruction and directing the picked multi-cycle instruction to a pipeline. The pipeline includes a pipeline control configured to detect a latency and a repeat rate of the picked multi-cycle instruction and to count clock cycles based on the detected latency and the detected repeat rate. The method and apparatus further include detecting the repeat rate and the latency of the picked multi-cycle instruction, and counting clock cycles based on the detected repeat rate and the latency of the picked multi-cycle instruction.

### FIELD OF INVENTION

This application is related to processors and methods of instruction processing.

### BACKGROUND

Dedicated pipeline queues have been used in multi-pipeline execution units of processors in order to achieve faster processing speeds. In particular, dedicated queues have been used for execution units having multiple pipelines that are configured to execute different subsets of supported instructions. But dedicated queuing has generated various bottlenecks and problems for scheduling instructions that require both numeric manipulation and retrieval/storage of data.

Additionally, processors are conventionally designed to process instructions that are typically identified by operation codes (OpCodes). In the design of new processors, it is important to process all of a standard set of instructions so that existing computer programs based on standardized codes will operate without the need for translating instructions into an entirely new code base. Processor designs may further incorporate the ability to process new instructions, but backwards compatibility to older instruction sets is often desirable.

Execution of instructions is typically performed in an execution unit of a processor core. To increase processing speed, multi-core processors have been developed. Also to facilitate faster execution throughput, “pipeline” execution of instructions within an execution unit of a processor core is used. Cores having multiple execution units for multi-thread processing are also being developed. However, there is a continuing demand for faster throughput for processors.

One type of standardized set of instructions is the instruction set compatible with the x86 chips, e.g. 8086, 286, 386, etc. that have enjoyed widespread use in many personal computers. Instruction sets, such as the “x86” instruction set, include operations requiring numeric manipulation, operations requiring retrieval and/or storage of data, and operations that require both numeric manipulation and retrieval/storage of data. To execute such instructions, execution units within processor cores have included two types of pipelines: arithmetic logic pipelines (“EX pipelines”) to execute numeric manipulations, and address generation pipelines (“AG pipelines”) to facilitate load and store operations.

To quickly and efficiently process instructions as required by a particular computer program, the program commands are decoded into operations within the supported set of instructions and dispatched to the execution unit for processing. Conventionally, an OpCode is dispatched that specifies what operation is to be performed along with associated information that may include items such as an address of data to be used for the operation and operand designations.

Dispatched operations are conventionally queued for a multi-pipeline scheduler of an execution unit. Queuing is conventionally performed with some type of decoding of a instruction's OpCode in order for the scheduler to appropriately direct the operations for execution by the pipelines with which it is associated within the execution unit.

Some instructions require more than one cycle to complete. Examples include multiply (MUL) and divide (DIV) operations. Each multi-cycle instruction has a known latency, i.e. each operation requires a predetermined number of cycles to complete.

Two aspects of accounting for multi-cycle instructions are discussed. First, unlike single cycle instructions which do not consume any resources outside of the cycle in which they are executed, multi-cycle instructions consume resources in successive clock cycles making those resources unavailable until the multi-cycle operation is complete. Thus, each multi-cycle operation has a resource contention associated with it which prevents additional multi-cycle operations from being issued using the same resource until the first multi-cycle operation is complete. This is called the repeat rate of the instruction.

Second, the results of multi-cycle instructions can only be distributed after the instruction is complete. Each multi-cycle instruction is given priority to distribute its result over a single cycle instruction. To avoid resource conflicts, counters have been used to track the latency of multi-cycle instructions. Since a multi-cycle instruction could be in any of the plurality of scheduler entries, each entry is required to have dedicated counter logic. When a multi-cycle instruction in a particular entry is picked, the counter associated with that entry will count the cycles as the instruction is being processed. When a predetermined threshold is reached, the counter will issue a flag to prevent an instruction from being picked which requires use of a result bus in the next cycle. The instruction distributes the result free of any resource conflicts.

One skilled in the art will recognize that the above noted issues increase chip area and power requirements for a scheduler block and decreases the processing efficiency of the execution unit since most instructions are single cycle.

### SUMMARY OF EMBODIMENTS

A method of processing multi-cycle instructions includes picking a multi-cycle instruction and directing the picked multi-cycle instruction to a pipeline. The method further includes detecting the repeat rate and latency of the picked multi-cycle instruction, and counting clock cycles based on the detected repeat rate and the latency of the picked multi-cycle instruction.

An apparatus for processing multi-cycle instructions includes a pipeline configured to process multi-cycle instructions. The pipeline includes a pipeline control configured to detect a latency and a repeat rate for each multi-cycle instruction and to count clock cycles based on the detected latency and the detected repeat rate. The apparatus further includes a scheduler queue configured to queue a plurality of instructions for pipeline processing, and a picker configured to pick a multi-cycle instruction from the scheduler queue and to direct the picked multi-cycle instruction to the pipeline for processing.

A computer-readable storage medium storing a set of instructions for execution by one or more processors to process multi-cycle instructions that includes a picking code segment for picking a multi-cycle instruction and a directing code segment for directing the picked multi-cycle instruction to a pipeline. The instructions further include a detecting code segment for detecting a repeat rate of the picked multi-cycle instruction and a counting code segment for counting clock cycles based on the detected repeat rate of the picked multi-cycle instruction. A detecting code segment for detecting a latency of the picked multi-cycle instruction and a counting code segment for counting clock cycles based on the detected latency of the picked multi-cycle instruction are also included.

### BRIEF DESCRIPTION OF THE DRAWINGS

FIG. 1 is a block diagram of a processor core configured in accordance with a disclosed embodiment.

FIG. 2 is a block diagram of a scheduler of the execution unit of the processor core of FIG. 1.

FIG. 3 is a graphic illustration of the format of a portion of an instruction information packet that may be dispatched from a decoder unit to an execution unit within the processor core illustrated in FIG. 1.

FIG. 4 is a block diagram of a processor pipeline.

FIG. 5 is a block diagram of a pipeline control.

FIG. 6 is a graphic illustration of the processing of a series of instructions containing a multi-cycle operation.

FIG. 7A is a block diagram of an example device in which one or more disclosed embodiments may be implemented.

FIG. 7B is a block diagram of an alternate example device in which one or more disclosed embodiments may be implemented.

### DETAILED DESCRIPTION OF EMBODIMENTS

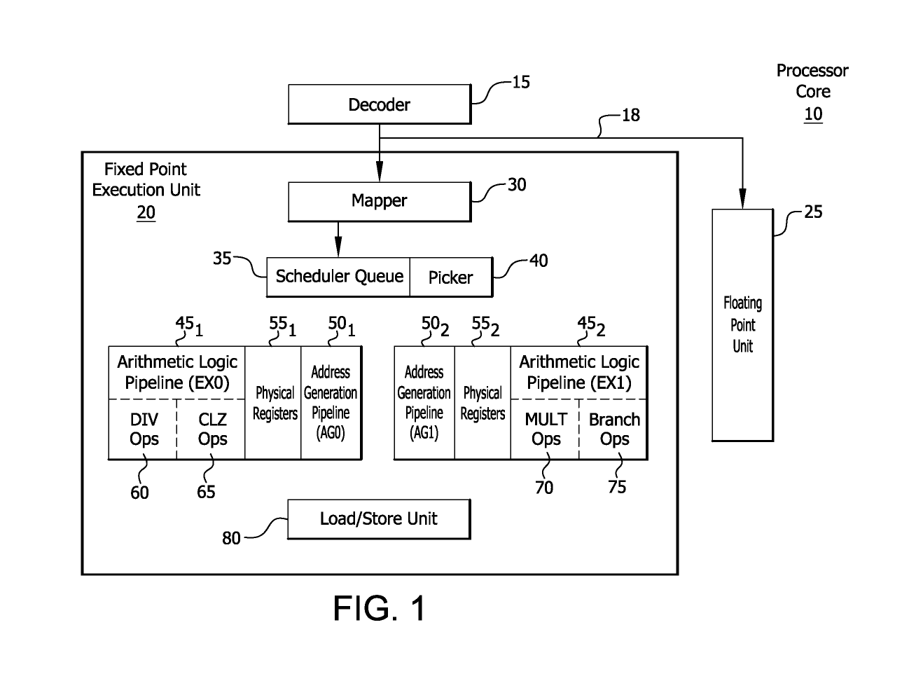

FIG. 1 is an example of an embodiment of a processor core 10. The processor core 10 has a decoder unit 15 that decodes and dispatches instructions to an execution unit 20. Multiple execution units may be provided for multi-thread operation. In the embodiment of FIG. 1, the execution unit may be, for example, a fixed point execution unit and a second fixed point execution unit (not shown) may be provided for dual thread processing.

A floating point unit 25 may be provided for execution of floating point instructions. The decoder unit 15 may dispatch instruction information packets over a common bus 18 to both the fixed point execution unit 20 and the floating point unit 25.

The execution unit 20 includes a mapper 30 associated with a scheduler queue 35 and a picker 40. These components control the selective distribution of operations among a plurality of arithmetic logic (EX) pipelines 45₁, 45₂ and address generation (AG) pipelines 50₁, 50₂ for pipeline execution. The pipelines execute operations queued in the scheduling queue 35 by the mapper 30 that are picked therefrom by the picker 40 and directed to an appropriate pipeline. In executing an instruction, the pipelines identify the specific kind of operation to be performed by a respective operation code (OpCode) assigned to that kind of instruction.

In the example illustrated in FIG. 1, the execution unit 20 includes four pipelines for executing queued operations. A first arithmetic logic pipeline EX0 45₁ and a first address generation pipeline AG0 50₁ are associated with a first set of physical registers (PRNs) 55₁ in which data may be stored relating to execution of specific operations by those two pipelines. A second arithmetic logic pipeline EX1 45₂ and a second address generation pipeline AG1 50₂ are associated with a second set of physical registers (PRNs) 55₂ in which data may be stored relating to execution of specific operations by those two pipelines.

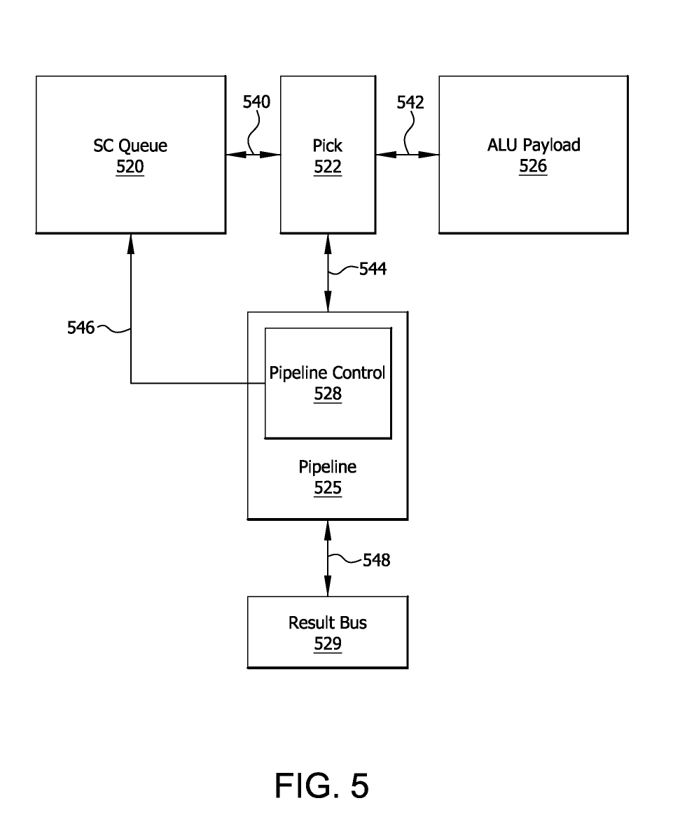

In the example execution unit shown in FIG. 1, the arithmetic pipelines EX0 45₁, EX1 45₂ have asymmetric configurations. The first arithmetic pipeline EX0 45₁ may be, for example, configured to process divide (DIV) operations 60 and count leading zero (CLZ) operations 65 within the execution unit 20. The second arithmetic pipeline EX1 45₂ may be, for example, configured to process multiplication (MUL) operations 70 and branch (BRN) operations 75 within the execution unit 20. A pipeline control (not shown) is attached to scheduling queue 35 and to the arithmetic logic (EX) pipelines 45₁, 45₂ and address generation (AG) pipelines 50₁, 50₂ as illustrated in FIG. 5 and described below.

DIV and MUL operations generally require multiple clock cycles to execute. The complexity of both arithmetic pipelines EX0 45₁ and EX1 45₂ may be reduced by not requiring either to perform all possible arithmetic operations and dedicating multi-cycle arithmetic operations for execution by only one of the two arithmetic pipelines. This saves chip real estate while still permitting a substantial overlap in the sets of operations that can be executed by the respective arithmetic pipelines EX0 45₁, EX1 45₂.

The processing speed of the execution unit 20 may be affected by the operation of any of its components. Since all the instructions that are processed must be mapped by the mapper 30 into the scheduling queue 35, any delay in the mapping/queuing process may adversely affect the overall speed of the execution unit.

The scheduler queue 35 may be configured as a unified queue for queuing instructions for all execution pipelines within the execution unit 20.

In the example illustrated in FIG. 1, the processing core 10 may be configured to support an instruction set compatible with “x86” chips, e.g. 8086, 286, 386, etc. An x86 based instruction set includes single component operations. These operations may have a single component requiring numeric manipulation or may have a single component requiring retrieval and/or storage of data. An x86 based instruction set also includes dual component operations, namely, operations that require both numeric manipulation and retrieval/storage of data. The arithmetic pipelines EX0 45₁, EX1 45₂ execute components of operations requiring numeric manipulation, and the address generation pipelines AG0 50₁, AG1 50₂ execute components of operations requiring retrieval/storage of data. The dual component operations require execution with respect to both types of pipelines.

Depending upon the kind of operation, an instruction executed in one of the pipelines may require a single clock cycle to complete or multiple clock cycles to complete. For example, a simple add instruction can be performed by either arithmetic pipeline EX0 45₁ or EX1 45₂ in a single clock cycle. However, arithmetic pipeline EX0 45₁ requires multiple clock cycles to perform a division operation, and arithmetic pipeline EX1 45₂ requires multiple clock cycles to perform a multiplication operation.

As an example, any given type of multi-cycle arithmetic operation may be dedicated to only one of the arithmetic pipelines EX0 45₁, EX1 45₂, and most single cycle arithmetic operations are within the execution domains of both arithmetic pipelines EX0 45₁, EX1 45₂. In the x86 based instruction set, there are various multi-cycle arithmetic operations, namely multi-cycle Division (DIV) operations 60 that fall within the execution domain of the arithmetic pipeline EX0 45₁, and multi-cycle Multiplication (MUL) operations 70 and multi-cycle Branch(BRN) operations 75 that fall within the execution domain of the arithmetic pipeline EX1 45₂. Accordingly, in the example, the execution domains of the arithmetic pipelines EX0 45₁, EX1 45₂ substantially overlap with respect to single cycle arithmetic operations, but they are mutually exclusive with respect to multi-cycle arithmetic operations.

There are three kinds of operations requiring retrieval and/or storage of data, namely, load (LD), store (ST) and load/store (LD-ST). These operations are performed by the address generation pipelines AG0 50₁, AG1 50₂ in connection with a Load-Store (LS) unit 80 of the execution unit 20 in FIG. 1.

Both LD and LD-ST operations generally are multi-cycle operations that typically require a minimum of 4 cycles to be completed by the address generation pipelines AG0, AG1. LD and LD-ST operations identify an address of data that may be loaded into one of the PRNs of the PRN sets 55₁, 55₂ associated with the pipelines. Time may be required for the LS unit 80 to retrieve the data at the identified address, before that data can be loaded in one of the PRNs. For LD-ST operations, the data that may be retrieved from an identified address may be processed and subsequently stored in the address from where it was retrieved.

ST operations typically require a single cycle to be completed by the address generation pipelines AG0 50₁, AG1 50₂. This may be because ST operations will identify where data from one of the PRNs of the PRN sets 55₁, 55₂ may be stored. Once that address is communicated to the LS unit 80, LS unit 80 may perform the actual storage so that the activity of the address generation pipeline AG0 50₁, AG1 50₂ may be complete after a single clock cycle.

In the example illustrated in FIG. 1, the mapper 30 may be configured to queue an instruction into an open queue position based on the instruction information packet received from the decoder 15. For example, the mapper 30 of execution unit 20 may be configured to receive two instruction information packets in parallel, which the mapper 30 may use to queue multiple instructions in a single clock cycle. In an example embodiment configured with a second, execution unit (not shown), the decoder 15 may be configured to dispatch four instruction information packets in parallel. Two of the instruction information packets are flagged for potential execution by the execution unit 20, and the other two are flagged for potential execution by the second execution unit. In the example, the floating point unit 25 scans the operation types (OpTypes) of all four instruction information packets dispatched in a given clock cycle. Any floating point instruction components indicated by the scan of the OpType fields data of the four instruction information packets are then queued and executed in the floating point unit 25.

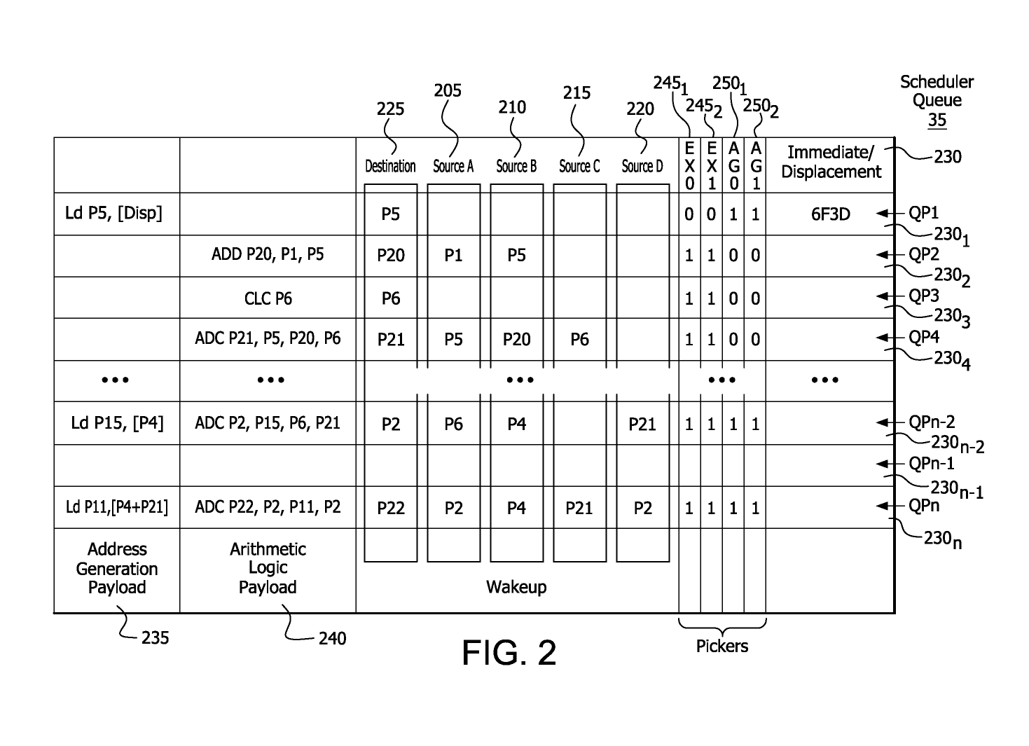

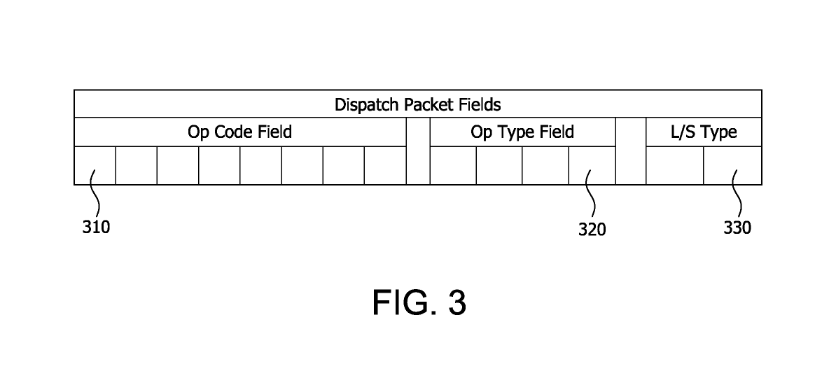

FIG. 2 is a block diagram of the scheduler queue 35 illustrating a plurality of queue positions QP1 230₁ . . . QPn 230ₙ. The scheduler queue 35 may, for example, have 40 positions. Generally, the scheduler queue 35 may have at least five times as many queue positions as there are pipelines to prevent bottlenecking. However when a scheduler queue that services multiple pipelines has too many queue positions, scanning operations can become time prohibitive and impair the speed in which the scheduler queue operates. In the example embodiment, the scheduler queue 35 may be sized such that queued instructions for each of the four pipelines can be picked and directed to the respective pipeline for execution in a single cycle. The full effect of the speed of scheduler queue 35 directing the execution of queued instructions can be realized because there may be no impediment in having instructions queued into the scheduler queue due to the speed of mapper 30 in queuing instructions based on OpTypes, as described below in connection with FIG. 3.

The mapper 30 may be configured to make a top to bottom scan and a bottom to top scan in parallel of the queue positions QP1 230₁-QPn 230ₙ to identify a top-most open queue position and bottom-most open queue position; one for each of the two instructions corresponding to two instruction information packets received in a given clock cycle.

Where the OpType field data of a dispatched instruction information packet indicates a floating point (FP) OpType, the instruction corresponding to that instruction information packet may not be queued because it may only require execution by the floating point unit 25. Accordingly, even when two instruction information packets are received from the decoder 15 in one clock cycle, one or both instructions may not be queued in the scheduler queue 35 for this reason.

Each queue position QP1 230₁ . . . QPn 230ₙ may be associated with memory fields including an Address Generation instruction (AG Payload) 235; an Arithmetic/Logic instruction (ALU Payload) 240; four Wake Up Content Addressable Memories (CAMs) Source A 205, Source B 210, Source C 215, and Source D 220 which identify addresses of PRNs that contain source data for the instruction; and a destination RAM 225 which identifies a PRN where the data resulting from the execution of the instruction may be stored.

A separate data field (Immediate/Displacement data field 230) may be provided for accompanying data that an instruction may use. Such data may be sent by the decoder in the dispatched instruction information packet for that instruction. For example, a load operation LD may be indicated in queue position QP1 230₁ that seeks to have data stored at an address 6F3D (indicated in the Immediate/Displacement data field 230) into the PRN identified as P5. In this example, the address 6F3D was data contained in the instruction information packet dispatched from the decoder 15, which information was transferred to the Immediate/Displacement data field 230 for queue position QP1 230₁ in connection with queuing that instruction to queue position QP1 230₁.

The address generation (AG) Payload field 235 and the arithmetic logic (ALU) payload field 240 are configured to contain the specific identity of an instruction as indicated by the instruction's OpCode along with relative address indications of the instruction's required sources and destinations that are derived from the corresponding dispatched instruction information packet. In connection with queuing, the mapper 30 translates relative source and destination addresses received in the instruction information packet into addresses of PRNs associated with the pipelines.

The mapper 30 tracks relative source and destination address data received in the instruction information packets so that it can assign the same PRN address to a respective source or destination where two instructions reference the same relative address. For example, P5 may be indicated as one of the source operands in an ADD instruction queued in queue position QP2 230₂, and P5 may also be identified as the destination address of the result of the LD operation queued in queue position QP1 230₁. This indicates that the dispatched instruction information packet for the LD instruction indicated the same relative address for the destination of the LD operation as the dispatched instruction information packet for the ADD instruction had indicated for one of the ADD source operands.

In the scheduler queue 35, flags are provided to indicate eligibility for picking the instruction for execution in the respective pipelines as indicated in the columns respectively labeled EX0 245₁, EX1 245₂, AG0 250₁, and AG1 250₂. The execution unit picker 40 may include an individual picker for each of the four pipelines EX0 picker 245₁, EX1 picker 245₂, AG0 picker 250₁, and AG1 picker 250₂. Each respective pipeline's picker scans the respective pipeline picker flags of the queue positions to find queued operations that are eligible for picking, i.e. are capable of being processed on at least one of the respective pipelines. Upon finding an eligible queued operation, the picker checks if the instruction is ready to be picked, i.e. the instruction does not have any other conflicts with other instructions in execution. If it is not ready, the picker resumes its scan for an eligible instruction that is ready to be picked. For example, EX0 picker 245₁ and AG0 picker 2501 scan the flags from the top queue position QP1 230₁ to the bottom queue position QPn 230ₙ and the EX1 picker 245₂ and AG1 picker 250₂ scan the flags from the bottom queue position QPn 230ₙ to the top queue position QP1 230₁ during each cycle. A picker will stop its scan when it finds an eligible instruction that is ready and then direct that instruction to its respective pipeline for execution. This may occur in a single clock cycle.

Readiness for picking may be indicated by the source wake up CAMs for the particular operation component being awake and indicating a ready state, meaning all source operands are present in the CAMs. Where there is no wake up CAM being utilized for a particular instruction component, the instruction is automatically ready for picking. For example, the LD operation queued in queue position QP1 230₁ does not utilize any source CAMs so that it is automatically ready for picking by either of AG0 picker 250₁ or AG1 picker 250₂ upon queuing. In contrast, the ADD instruction queued in queue position QP2 230₂ uses the queue position's wake up CAMs Source A 205 and Source B 210. In other words, the ADD instruction queued in queue position QP2 230₂ may not be ready to be picked until the PRNs P1 and P5 have been indicated as ready by wake up CAMs Source A 205 and Source B 210.

If one of the arithmetic pipelines is performing a multi-cycle operation, the pipeline may provide its associated picker with an instruction to suspend picking operations until the arithmetic pipeline completes execution of that multi-cycle operation. In contrast, the address generation pipelines may be configured to commence execution of a new address generation instruction without awaiting the retrieval of load data for a prior instruction. Accordingly, the pickers will generally attempt to pick an address generation instruction for each of the address generation pipelines AG0 250₁, AG1 250₂ for each clock cycle when there are available address generation instructions that are indicated as ready to pick.

The queue position's picker flags may be set in accordance with the pipeline indications in FIG. 3, discussed in detail below, with respect to the instruction's OpType and, where needed, LD/ST Type. Where the instruction's OpType and LD/ST Type indicate that it is not a dual component instruction, the mapper's process for proceeding with queuing the instruction may be straight forward.

In the single component instruction case, the pipeline designations indicate that the instruction may be either an arithmetic operation or an address generation operation through the eligible pipe indication. Where an arithmetic operation is indicated, the ALU payload field 240 of the queue position may be filled with the OpCode data to indicate the specific kind of operation and appropriately mapped PRN address information indicating sources and a destination. Where an address generation operation is indicated, the AG payload field 235 of the queue position may be filled with the OpCode data to indicate the specific kind of operation and appropriately mapped PRN address information indicating sources and a destination. In both cases, the wake up CAMs Source A 205, Source B 210, Source C 215, and Source D 220 can be supplied with the sources indicated in the payload data, and the destination RAM 225 can be supplied with the destination address indicated in the payload data.

As noted above, in conventional execution units, decoding of an instruction's OpCode may typically be performed in order to queue operations for execution on an appropriate pipeline. This OpCode decoding correspondingly consumes processing time and power. Unlike conventional execution units, the example mapper 30 does not perform OpCode decoding in connection with queuing operations into the scheduling queue 35.

To avoid the need for OpCode decoding by the mapper 30, the decoder 15 may be configured to provide a relatively small additional field in the instruction information packets that it dispatches. This additional field reflects a defined partitioning of the set of instructions into categories that directly relate to execution pipeline assignments. Through this partitioning, the OpCodes are categorized into groups of operation types (OpTypes).

The partitioning may be such that there are at least half as many OpTypes as there are OpCodes. As a result, an OpType can be uniquely defined through the use of at least one less binary bit than may be required to uniquely define the OpCodes.

Configuring the mapper 30 to conduct mapping/queuing based on OpType data instead of OpCode data enables the mapper 30 to perform at a higher speed, since there may be at least one less bit to decode in the mapping/queuing process. Accordingly, the decoder 15 may be configured to dispatch instruction information packets that include a low overhead, i.e. relatively small, OpType field in addition to a larger OpCode field. The mapper 30 may then be able to utilize the data in the OpType field, instead of the OpCode data, for queuing the dispatched operations. The OpCode data may be passed via the scheduler to the pipelines for use in connection with executing the respective instruction, but the mapper does not need to do any decoding of the OpCode data for the mapping/queuing process.

In the example discussed below where support may be provided for an “x86” based instruction set, the mapper 30 only needs to process a 4-bit OpType, instead of an 8-bit OpCode in the mapping/queuing process. This translates into an increase in the speed of the mapping/queuing process. The mapping/queuing process may be part of a timing path of the execution unit 20 since all instructions to be executed must be queued. Thus an increase in the speed of the mapping/queuing process in turn permits the execution unit 20 as a whole to operate at an increased speed.

As noted above, in an example embodiment, the processing core 10 may be configured to support an instruction set compatible with the “x86” chips. This requires support for about 190 standardized “x86” instructions. As illustrated in FIG. 3, an OpCode field 310 in the instruction information packets dispatched from the decoder 15 may be configured with 8 bits in order to provide data that uniquely represents an instruction in an x86 based instruction set. The 8-bit OpCode field 310 enables the unique identification of up to 256 instructions, so that an instruction set containing new instructions in addition to existing x86 instructions may be readily supported.

The x86 based instruction set may be partitioned into a plurality of OpTypes. These OpTypes are uniquely identified by a four digit binary number as shown. As graphically illustrated in FIG. 3, a four bit OpType field 320 may be provided in the instruction information packets dispatched from the decoder 15. For example, the decoder 15 may be configured with a lookup table and/or hardwiring to identify an OpType from an OpCode for inclusion in each instruction information packet. Since the OpType is reflective of pipeline assignment information, it may not be used in the decoding processing performed by the decoder 15. Accordingly, there may be time to complete an OpType lookup based on the OpCode without delaying the decoding process and adversely affecting the operational speed of the decoder 15.

The use of an OpType field 310 also provides flexibility for future expansion of the set of instructions that are supported without impairing the mapping/queuing process. Where more than 256 instructions are to be supported, the size of the OpCode field 310 would necessarily increase beyond 8-bits. However, as long as the OpCodes can all be categorized into 16 or less OpTypes, a 4-bit OpType 320 field can be used.

A two bit load/store type (LD/ST Type) 330 may be provided in the instruction information packets dispatched from the decoder 15 to indicate whether the instruct has a LD, ST or LD-ST component or no component requiring retrieval/storage of data. A 2-bit identification of these characteristics may be reflected in the LD/ST Type column in FIG. 3 where 00 indicates the instruction has no component requiring retrieval/storage of data.

In an example embodiment there may be three OpTypes executable on only one of two arithmetic pipelines EX0 45₁ or EX1 45₂. DIV operations execute exclusively on EX0 45₁, while MUL and BRN operations execute exclusively on EX1 45₂. Such arithmetic multi-cycle operations have known latency, meaning the number of cycles each operation requires may be known in advance of execution by the EX0 45₁ or EX1 45₂.

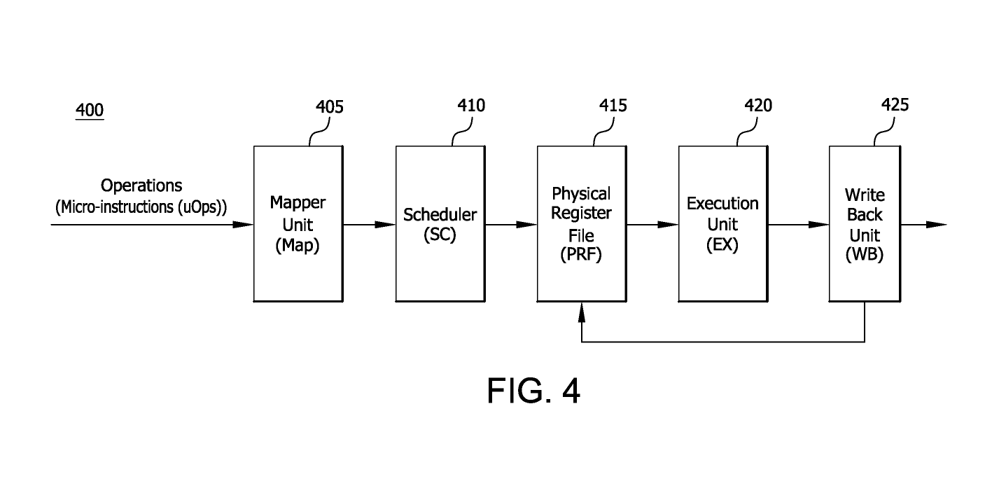

Referring to FIG. 4, an illustration of a processor pipeline 400 is shown. Pipeline 400 including a mapper unit (Map) 405, a scheduler (SC) 410, a physical register file (PRF) 415, an execution unit (EX) 420 and a write back unit (WB) 425. The mapper unit 405 performs register renaming. The scheduler 410 contains an instruction queue similar to that of FIG. 2. The PRF 415 may be a memory array of registers that stores operand data. The data stored in the PRF 415 may be indicated by a PRN index. The PRF 415 performs the operands read for all instructions that are issued for execution by the execution unit 420. The write back unit 425 writes the results output from the execution unit 420 back to the PRF 415.

FIG. 5 illustrates a process for issuing an instruction that includes a multi-cycle operation in accordance with an example embodiment. One skilled in the art will recognize that the process may be applicable to any number of parallel pipelines (not shown) designed to execute known latency operations.

Referring to FIG. 5, picker 522 scans through data path 540 for instructions in the scheduler queue 520 that are both eligible and ready for picking. Once an instruction is found eligible and ready for picking, picker 522 reads data from Arithmetic/Logic (ALU) Payload 526 through data path 542, including the OpCode for the instruction. The OpCode, along with other payload data, may be wrapped in a instruction information packet and may be sent through data path 544 to pipeline 525 for processing. Pipeline 525 includes a pipeline control 528. Pipeline control 528 analyzes the data in the instruction information packet, including the OpCode, OpType, and the Operand data size to determine the latency of the operation. If the instruction is a single cycle operation, pipeline control 528 sends the instruction through pipeline 525 for execution and prepares to receive the next instruction from the picker 522.

Latency and Repeat Rate are determined from the instruction packet, including the Opcode, OpType and Operand data size. Examplary data sizes are 8, 16, 32, and 64 bits. For example, for 8-bit and 16-bit MULs the latency may be 4 cycles and repeat rate may be 2 cycles. For 32b data size, latency may be 5 cycles and repeat rate may be 2 cycles. For 64-bit data size, latency may be 7 cycles and repeat rate may be 4 cycles. For DIVs, latency may determined by one of the Operand Values (e.g., iteration count) and repeat rate may be fixed as latency minus 2 cycles, Variable latency for DIVs is due to the variable nature of the iteration count. This iteration count may be predetermined by software.

If the instruction contains a multi-cycle operation, for example a MUL operation, pipeline control 528 determines the length of the clock cycle latency for the multi-cycle operation, i.e. the number of cycles the operation requires to execute. Pipeline control 528 also determines the repeat rate for the operation, i.e., the number of cycles that must pass before the same type of multi-cycle operation may be picked again. Pipeline control 528 then sends an indication back to picker 522 along data path 544 that prevents any additional multi-cycle instructions from being picked for the duration of the repeat rate count.

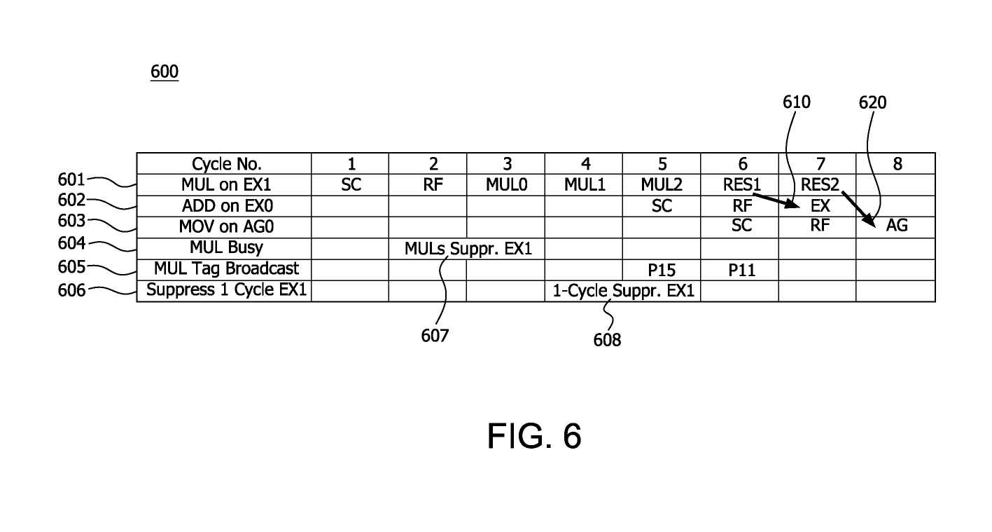

When a multi-cycle operation is executed, scheduler queue 520 and picker 522 no longer track the instruction. Thus, in another aspect of the embodiment, an alternate method of waking up an operation dependent on the multi-cycle operation may be provided. As illustrated in FIG. 5, pipeline control 528 distributes PRN tags through an alternate tag broadcast data path 546 to the source CAMs in a dependency array located in the scheduler queue 520. Pipeline Control broadcasts the PRN tags through alternate broadcast data path 546 such that the dependent operation may be awakened two cycles before the result of the multi-cycle operation is distributed on the result bus 529. Referring to FIG. 6, an example of this alternate broadcast is shown and described in further detail below.

Pipeline control 528 also regulates the use of result bus 529 by sending an instruction to picker 522 that prevents single cycle operations from being picked in the same cycle when the multi-cycle operation is completed.

An example embodiment of a pipeline control regulation process is illustrated in FIG. 6. The following exemplary series of operations is illustrated:

MUL P15:P11, P2, P33—Multiply register contents in Operands P2 and P33 and write the results in P15 and P11. Multiply operations can result in double width results requiring two register entries to store.

ADD P34, P15, Imm32—Add Operand P15 with Immediate data (32 bits) and write result in P34.

MOV P22, P11—Move contents of P11 into P22.

In accordance with the example embodiment (see FIG. 5), pipeline control 528 processes a representative multi-cycle operation, in this example a MUL operation 601 (see FIG. 6) with a repeat rate of two cycles and a latency of five cycles. In clock cycle 1, the MUL operation 601 may be scheduled. The repeat rate restriction may be handled by a “MUL Busy” indication 604 that causes MUL operations to be ineligible for picking for the duration of the repeat rate, thereby preventing picker 522 from picking those operations. This is shown in FIG. 6 in cycles 2 and 3 as a MUL Suppr. EX1 607. Thus, additional MUL operations are suppressed during cycles 2 and 3.

Pipeline control 528 also issues a “Suppress 1 cycle EX1” indication 606 that causes single cycle operations to be ineligible for picking and prevents the picker from scheduling a single cycle operation on pipeline 525 in cycles 4 and 5 which is shown as 1-Cycle Suppr. EX1 608 in FIG. 6. This operation avoids result bus conflict with the MUL result distributions 610 and 620 shown in cycles 6 and 7.

One skilled in the art will notice that the use of the alternate broadcast data path 546 (FIG. 5) allows for a minimum latency result for the dependent operations following the completion of the MUL multi-cycle operation. In the example illustrated in FIG. 6, the MUL operation 601 will need to write to two destination register addresses, P15 and P11. Pipeline control 528 broadcasts the P15 and P11 PRN tags through alternate tag broadcast data path 546, as shown in cycles 5 and 6 as MUL Tag Broadcast 605. The ADD operation 602 and MOV operation 603 are executed by one of a plurality of other pipelines as shown, for example, in FIG. 1. In the example illustrated in FIG. 6, the ADD operation 602 may be executed by the arithmetic pipeline EX0 45₁ in FIG. 1, and the MOV operation 603 may be executed by the address generation pipeline AG0 50₁ in FIG. 1.

When the MUL operation 601 is complete, there are two results that get distributed. In cycle 6, when there is no dependent operation picked for execution in the next cycle, the first result P15 may be written back into the physical register for use by a future picked instruction. When a dependent instruction is picked as a result of the alternate tag broadcast discussed above, the result P15 may be bypassed directly to the pipeline executing the dependent instruction. In this example, it is sent to EX0 45₁ which executes the ADD instruction 602 through bypass path 610 in cycle 7. Note that the alternate broadcast of P15 in cycle 5 awakens the dependent ADD instruction such that the result of the MUL operation, issued over the result bus RES1 and written into P15 in cycle 6, is bypassed directly to execute the ADD instruction in cycle 7. In the same way, since the MOV instruction 603 may be picked by the alternate tag broadcast, the result P11 may be bypassed to AG0 50₁ for the execution of the MOV instruction 603 through bypass path 620. One skilled in the art will notice this same process may be used regardless of whether the dependent operations are awakened by the alternate tag broadcast during multi-cycle instruction processing or by the normal wake up during single cycle instruction processing. Bypass logic may receive Destination and source PRN Tags from ALU Payload 526 and pipeline control 528. However, it may be a separate logic than pipeline control 528 that attempts to match Destinations to sources of Operations which were picked in any particular cycle.

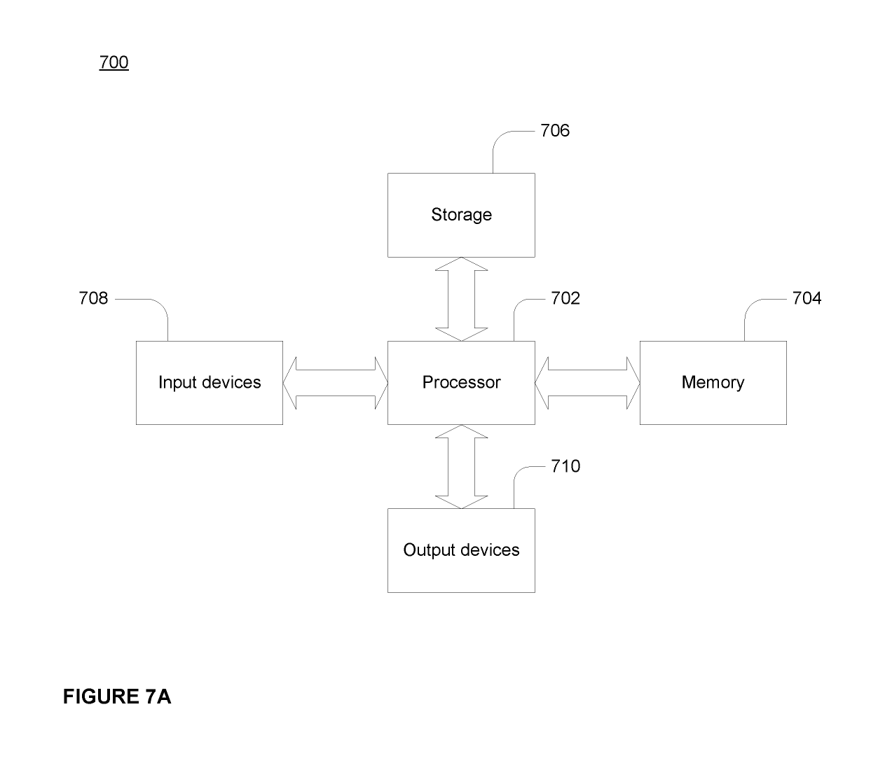

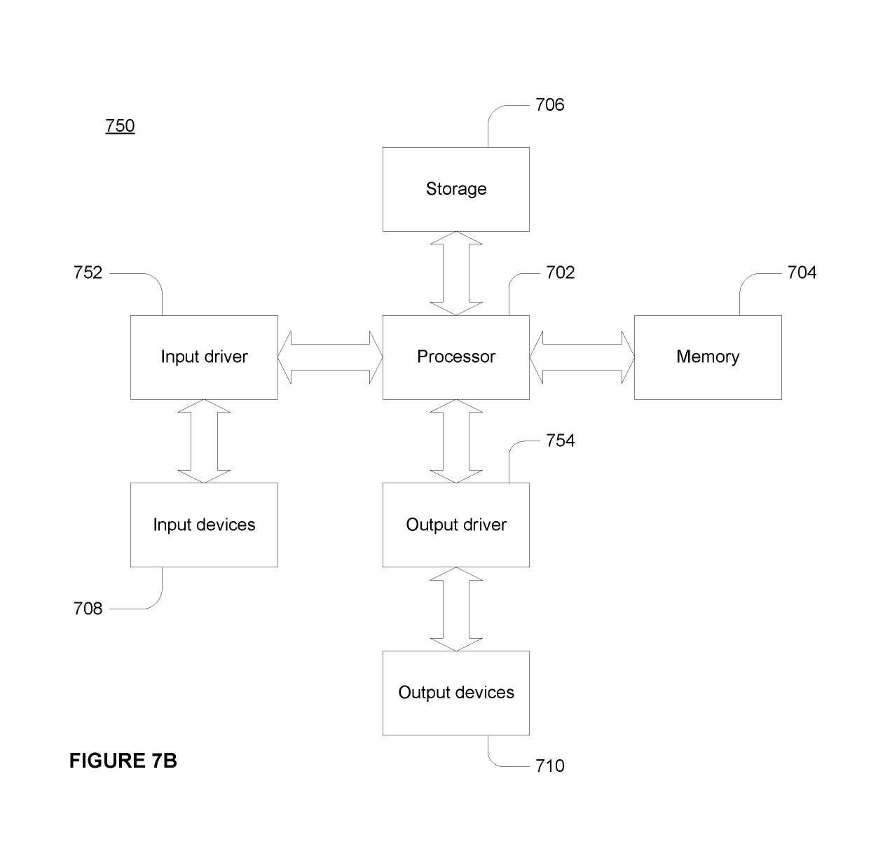

FIG. 7A is a block diagram of an example device 700 in which one or more disclosed embodiments may be implemented. The device 700 may include, for example, a computer, a gaming device, a handheld device, a set-top box, a television, a mobile phone, or a tablet computer. The device 700 includes a processor 702, a memory 704, a storage 706, one or more input devices 708, and one or more output devices 710. It is understood that the device may include additional components not shown in FIG. 7A.

The processor 702 may include a central processing unit (CPU), a graphics processing unit (GPU), a CPU and GPU located on the same die, one or more processor cores, wherein each processor core may be a CPU or a GPU. The memory 704 may be located on the same die as the processor 702, or may be located separately from the processor 704. The memory 704 may include a volatile or non-volatile memory, for example, random access memory (RAM), dynamic RAM, or a cache.

The storage 706 may include a fixed or removable storage, for example, hard disk drive, solid state drive, optical disk, or flash drive. The input devices 708 may include a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 710 may include a display, a speaker, a printer, a haptic feedback device, one or more lights, an antenna, or a network connection (e.g., a wireless local area network card for transmission and/or reception of wireless IEEE 802 signals).

FIG. 7B is a block diagram of an alternate example device 750 in which one or more disclosed embodiments may be implemented. Elements of the device 750 which are the same as in the device 700 are given like reference numbers. In addition to the processor 702, the memory 704, the storage 708, the input devices 708, and the output devices 710, the device 750 also includes an input driver 752 and an output driver 754.

The input driver 752 communicates with the processor 702 and the input devices 708, and permits the processor 702 to receive input from the input devices 752. The output driver 754 communicates with the processor 702 and the output devices 710, and permits the processor 702 to send output to the output devices 710.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors may be any one of a variety of processors such as a Central Processing Unit (CPU) or a Graphics Processing Unit (GPU). For instance, they may be x86 processors that implement an x86 64-bit instruction set architecture and are used in desktops, laptops, servers, and superscalar computers, or they may be Advanced RISC (Reduced Instruction Set Computer) Machines (ARM) processors that are used in mobile phones or digital media players. Other embodiments of the processors are contemplated, such as Digital Signal Processors (DSP) that are particularly useful in the processing and implementation of algorithms related to digital signals, such as voice data and communication signals, and microcontrollers that are useful in consumer applications, such as printers and copy machines. Other embodiments may include, by way of example, a plurality of processors, one or more processors in association with a DSP core, a controller, a microcontroller, Application Specific Integrated Circuits (ASICs), Field Programmable Gate Arrays (FPGAs) circuits, any other type of integrated circuit (IC), and/or a state machine.

Typically, a processor receives instructions and data from a read-only memory (ROM), a random access memory (RAM), and/or a storage device. Storage devices suitable for embodying computer program instructions and data include all forms of non-volatile memory, including by way of example, semiconductor memory devices, magnetic media such as internal hard disks and removable disks, magneto-optical media, and optical media such as CD-ROM disks and DVDs. In addition, while the illustrative embodiments may be implemented in computer software, the functions within the illustrative embodiments may alternatively be embodied in part or in whole using hardware components such as ASICs, FPGAs, or other hardware, or in some combination of hardware components and software components.

Embodiments of the invention may be represented as instructions and data stored on a computer readable memory. For example, aspects of the invention may be included in a hardware description language (HDL) code stored on such computer readable media. Such instructions, when processed may generate other intermediary data (e.g., netlists, GDS data, or the like) that can be used to create mask works that are adapted to configure a manufacturing process (e.g., a semiconductor fabrication facility). Once configured, such a manufacturing process is thereby adapted to manufacture processors or other semiconductor devices that embody aspects of the present invention.

While specific embodiments of the present invention have been shown and described, many modifications and variations could be made by one skilled in the art without departing from the scope of the invention. The above description serves to illustrate and not limit the particular invention in any way.

What is claimed is:

1. A method of processing a multi-cycle instruction comprising:
detecting a repeat rate and a latency of a first multi-cycle instruction; and
counting clock cycles based on the detected repeat rate and the detected latency of the first multi-cycle instruction.

2. The method according to claim 1, further comprising:
directing the multi-cycle instruction to a pipeline.

3. The method according to claim 2, wherein the pipeline includes a pipeline control configured to perform the detecting and counting.

4. The method according to claim 2 further comprising:
directing the result of the first multi-cycle instruction to another pipeline executing a dependent instruction, on a condition that the dependent instruction is executed in the other pipeline in the same clock cycle that a result of the first multi-cycle instruction is distributed.

5. The method according to claim 1 further comprising
indicating that a second multi-cycle instruction is not eligible to be processed for a duration of the repeat rate of the first multi-cycle instruction.

6. The method according to claim 1 further comprising:
indicating that a second multi-cycle instruction is eligible to be picked on a condition that a count of the repeat rate of the first multi-cycle instruction has expired.

7. The method according to claim 1 further comprising:
broadcasting a destination address where a result of the first instruction is stored.

8. The method according to claim 7, wherein the broadcasting occurs a predetermined number of cycles before the result is to be distributed.

9. The method according to claim 1 further comprising:
indicating, a predetermined number of cycles before a result of the first multi-cycle instruction is distributed, that a single cycle instruction is not eligible to be picked.

10. An apparatus for processing multi-cycle instructions comprising:
a pipeline configured to process multi-cycle instructions; and
a pipeline control configured to detect a latency and a repeat rate for each multi-cycle instruction and to count clock cycles based on the detected latency and the detected repeat rate.

11. The apparatus according to claim 10, further comprising:
a scheduler queue configured to queue a plurality of instructions for pipeline processing;
a picker configured to pick a multi-cycle instruction from the scheduler queue and to direct the picked multi-cycle instruction to the pipeline for processing; and
wherein the pipeline control is further configured to indicate whether the pipeline is eligible for multi-cycle instruction processing based on the repeat rate of the picked multi-cycle instruction.

12. The apparatus according to claim 11, wherein the pipeline control is further configured to indicate whether a single cycle instruction is eligible to be picked a predetermined number of cycles before the result of the picked multi-cycle instruction is distributed

13. The apparatus according to claim 11, wherein the pipeline control is configured to broadcast a destination address where the result of the picked multi-cycle instruction is stored

14. The apparatus according to claim 13 wherein the broadcasting occurs a predetermined number of cycles before the result of the picked multi-cycle instruction is distributed

15. The apparatus according to claim 11 further comprising
a plurality of other pipelines configured to configured to process multi-cycle instructions, wherein each pipeline is configured to process an exclusive subset of multi-cycle instructions; and
wherein the pipeline control is further configured to direct the result of the picked multi-cycle instruction executing a dependent instruction, on a condition that the dependent instruction is executed in the other pipeline in the same clock cycle that a result of the picked multi-cycle instruction is distributed.

16. A computer-readable storage medium storing a set of instructions for execution by one or more processors to process multi-cycle instructions, the set of instructions comprising:
a picking code segment for picking a multi-cycle instruction;
a directing code segment for directing the picked multi-cycle instruction to a pipeline;
a detecting code segment for detecting a repeat rate and a latency of the picked multi-cycle instruction;
a counting code segment for counting clock cycles based on the detected repeat rate and the detected latency of the picked multi-cycle instruction.

17. The computer-readable storage medium of claim 16, wherein the instructions are hardware description language (HDL) instructions used for the manufacture of a device.
